(19) United States
(12) Patent Application Publication
(10) Pub. No.: US 2022/0290556 A1
(43) Pub. Date: Sep. 15, 2022

(54) RISK-BASED FINANCIAL OPTIMIZATION METHOD FOR SURVEILLANCE PROGRAMS

(71) Applicant: Saudi Arabian Oil Company, Dhahran (SA)

(72) Inventor: Nasser Mubarak Al-Hajri, Abqaiq (SA)

(73) Assignee: Saudi Arabian Oil Company, Dhahran (SA)

(21) Appl. No.: 17/197,859

(22) Filed: Mar. 10, 2021

(51) Int. Cl. E21B 47/12; E21B 47/002; E21B 47/003

(52) U.S. Cl. CPC E21B 47/12; E21B 47/0025; E21B 47/003

(57) ABSTRACT

Systems and methods include a computer-implemented method for predicting optimization scenarios. Health and defect categories are generated from historical well integrity survey data for surveyed wells. For each asset, a reference point in time and fixed analysis time durations are generated for the health and defect categories. A probability of defect (PD) cumulative distribution function (CDF) for predicting probabilities of defects over time is generated. A probability of health (PH) CDF for predicting health probabilities over time is generated. An overall probability of failure (P_{f}) function for predicting the P_{f} for the asset is determined. An overall age CDF for the asset is determined and is fitted to optimization scenarios for annual surveys of assets under different survey frequencies. A prediction for a number of failures is determined for each of the optimization scenarios. The predictions are provided to a user for selection of an optimization scenario.

### TECHNICAL FIELD

The present disclosure applies to risk estimation and financial optimization.

### BACKGROUND

Surveillance programs of a company's assets are essential to maintaining the company's integrity and functionality. Asset owners conduct routine checks of their assets, for example equipment, to identify possible maintenance needs. When assets are properly surveyed and corrective upkeep actions are taken, the asset owner can guarantee continuous and uninterrupted operations. Surveillance programs can either be proactive or reactive depending on the survey type. Conducting surveys on an asset typically requires a financial investment which can involve, for example, taking the asset out of service during the routine check.

The frequency upon which an asset is surveyed for integrity and maintenance can vary depending on the asset owner's judgment and discretion. Asset owners may often assign arbitrary frequencies for their surveillance programs based on prior experience with the assets. For example, an asset owner can choose to survey an asset once or twice per year or at some other time frequency. The optimum survey frequency can be the frequency that provides the asset owner with the lowest financial investment and the lowest risk of equipment failure.

### SUMMARY

The present disclosure describes techniques used in a risk-based financial optimization process for surveillance programs. In some implementations, a computer-implemented method includes the following. A health category and a defect category are generated from data points of historical well integrity survey data for surveyed wells. For each asset of a well, a reference point in time and fixed analysis time durations are generated for the health and defect categories of the data points. A probability of defect (PD) cumulative distribution function (CDF) for predicting probabilities of defects over time is generated using the fixed analysis time durations for the health and defect categories of the data points. A probability of health (PH) CDF for predicting health probabilities over time is also generated using the fixed analysis time durations for the health and defect categories of the data points. An overall probability of failure (P_{f}) function for predicting the P_{f} for the asset is determined using the PD CDF and the PH CDF. An overall age CDF for the asset is determined using the overall P_{f} function. The overall age CDF for the asset is fitted to optimization scenarios for annual surveys of assets under different survey frequencies. A prediction for a number of failures is determined for each of the optimization scenarios. The predictions are provided to a user for selection of an optimization scenario.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. Use of the techniques of the present disclosure can solve the technical problem of assigning arbitrary surveillance frequencies without risk or financial estimation. For example, an amount of surveillance that is needed in day-to-day operations can be quantified within an acceptable risk and financial investment. An application can be created to conduct a surveillance optimization process by studying past surveillance program data and calculating associated optimization impacts based on scenarios proposed by a user.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a diagram showing an example of a time duration flow of fixed analysis time durations, according to some implementations of the present disclosure.

FIG. 2 is a diagram showing an example of a cumulative distribution function (CDF) 200 including a probability of defect (PD), according to some implementations of the present disclosure.

FIG. 3 is a diagram showing an example of a cumulative distribution function (CDF) 300 including a probability of health (PH), according to some implementations of the present disclosure.

FIG. 4 is a diagram showing an example of a calculated overall probability of failure for temperature surveys including a probability of failure (P_{f}), according to some implementations of the present disclosure.

FIG. 5 is a diagram showing an example of a Probability of age for temperature surveys including a probability of age (PA), according to some implementations of the present disclosure.

FIG. 6 is a graph showing examples of a risk of failure plot and a cost savings plot 604, according to some implementations of the present disclosure.

FIG. 7 is a flowchart of an example of a method for selecting an optimized survey frequency for a well based on defect and health probabilities, according to some implementations of the present disclosure.

FIG. 8 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for using a risk-based approach in providing a financial optimization process for surveillance programs. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

A financial optimization process for surveillance programs can be developed using big data analytics, for example, based on a risk-based financial optimization model inspired by the Fourth Industrial Revolution (4IR). An objective of the model can include a process for optimizing financial resources related, for example, to the frequency of conducting well integrity surveys while maintaining low operational risk. Use of the process can provide new frequencies which balance risks of conducting fewer surveys with associated financial impacts (avoiding costs, for example) for a surveillance program being optimized. This process can be applied to other types of surveillance. Optimization can refer, for example, to achieving results in surveillance programs resulting in benefit-to-cost ratios or results exceeding a pre-defined threshold.

Use of techniques of the present disclosure can provide a risk-based financial optimization model for surveillance programs serving asset owners. The optimization model can balance risks with financial investments to provide the asset owner with several optimization scenarios (at low risk and low investment). This can help to ensures that surveys are not overdone and do not cause financial strains on the asset owner. Asset owners can adopt an optimized frequency for their assets based on optimization scenarios offered by the model. The model can be based on techniques associated with big data analytics. An example used to explain the model is well integrity surveillance. In this example, optimization of surveillance programs can allow an oil operator to obtain a return on past investment that is made by collecting historical well integrity data. The optimization of well integrity surveillance frequencies can be used as an example to illustrate the workflow of methodologies used in the present disclosure.

Well integrity surveillance is a practice of conducting surveys on petroleum wells to check the integrity of the well equipment. Equipment that requires checking can include, for example, well downhole pipes and surface/subsurface flow control valves. Common types of surveys include the following.

A wellhead integrity test is a survey that is conducted using pressure to inquire about the functionality and pressure sealing integrity of wellhead tree valves. The criteria of a successful wellhead integrity test includes determining that the valves are able to contain the well pressure without passing pressure outside the well to the surface flowline or atmosphere.

A surface/subsurface safety valves test is a survey that is conducted using pressure to determine the functionality and pressure sealing integrity of the emergency surface/subsurface safety valves. Criteria of a successful surface/subsurface safety valves test includes determining that valves function properly by sealing the well pressure when activated.

A landing base inspection is a survey that is conducted using electronics to measure the metal loss thickness of the metal base (commonly known as landing base) that seats the wellhead tree valves. The criteria of a successful landing base inspection includes determining that the landing base to has an acceptable metal loss without fluid leaks from inside the well to surroundings. Acceptable metal loss (for example, based on a metal thickness predefined by oil operators) can depend on the type and size of the landing base.

Annuli surveys include surveys conducted using pressure to inquire about the integrity of the annuli (the cement-filled space between each downhole pipe). The criteria of a successful annuli survey includes determining that no pressure is measured between the pipes and no fluid is leaking through the cement from a downhole reservoir to the surface.

Temperature surveys include surveys conducted using temperature recording electronics to measure downhole temperature profiles and to identify possible downhole pipe leaks. A temperature survey identifying a temperature profile not following a typical downhole temperature profile can be flagged as anomalous and can be further investigated, for example, to identify a pipe leak. Typical downhole temperature profiles can include geothermal trends that increase with depth. The criteria of a successful temperature survey can include obtaining a downhole temperature recording that conforms to base temperature profiles without significant increase/decrease of temperature readings.

Corrosion logs include surveys conducted using metal loss recording electronics to measure downhole pipes' remaining metal and loss thicknesses. The criteria of a successful corrosion log includes identifying and recording downhole pipes metal loss thicknesses that are lower than a minimum metal loss thickness that is predetermined by a well owner as being safe for operations.

For the purpose of explaining an optimization model workflow, temperature surveys can be used as an example. The optimization model workflow can describe the risk-based financial optimization model from data collection to model building, including the following steps.

In a data collection and categorization step, past historical well integrity survey data is collected. The data collection can include, for example, collecting all previous temperature logging results for surveyed wells. The collected data can then be classified into health and defect categories. A survey can be deemed a health data point if the survey results do not identify a leak in the downhole pipe that requires maintenance. Conversely, the survey can be deemed a defect data point if the survey shows an anomalous temperature profile that indicates the presence of a downhole pipe leak that requires maintenance. Completing the data collection with thorough quality assurance can assure use of the data as inputs to the risk-based financial optimization model. High quality data collection and classification can ensure accuracy of the model and its prediction results. In cases in which oil operators have large databases, artificial-intelligence based queries can be used to collect and then classify the data into health and defect categories.

In a health and defect identification step, a reference point of time can be identified for asset/equipment health or defect duration. The reference point can be a time the asset/equipment was first installed or a time the asset/equipment was refurbished or maintained from a previous failure. As an example, for a temperature survey that identifies a failure such as a downhole pipe leak in 2007 for a pipe first installed in 2005, the defect time duration is 2 years. In another example, if the pipe was installed to cover a previous leak in 2005, then the defect time duration identified in 2007 is 2 years. In a third example, if a pipe was first installed in 2015 and continues to be healthy without identifying a leak until a present time (for example, 2021), then the health time duration is 6 years.

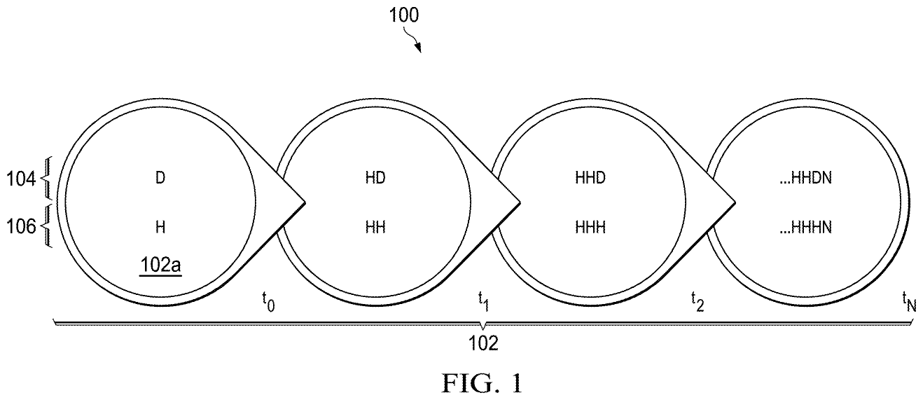

In a step for specifying fixed analysis time durations, a normalized analysis time duration is required to systematically and representatively execute the optimization model workflow. The normalized or fixed time analysis should preferably be consistent for all types of surveillance. The specific analysis time duration can be, for example, one year (or 365 days). Other specific analysis time durations can be used depending on the available raw health and defect data points. The theoretical premise behind analysis time durations can be explained with reference to FIG. 1.

FIG. 1 is a diagram showing an example of a time duration flow 100 of fixed analysis time durations, according to some implementations of the present disclosure. The time duration flow 100 includes fixed time durations 102 at time (t) following a sequence t₀, t₁, t₂, . . . t_{N}. Time (t) increases by one fixed analysis time duration. For the temperature surveys example used to explain the model methodology workflow, a fixed time duration of 1 year (365 days) can be used. At the first fixed analysis time duration 102a (t₀=365 days), all raw data points can be classified into health and defect. Health (H) and defect (D) patterns 104 and 106 can correspond to the health/defect of different assets over time, starting at to. When a defect is identified at t₀, its defect time in days is recorded, and the asset health/defect time is reset after maintenance. The health points are further considered from t₀ to the subsequent time zones until a defect is identified and its time is recorded in days. The assets that continue to be healthy until present time are identified, and their time are recorded in days.

A step for developing a cumulative distribution function for defect data points can be used to obtain a probability of defect (PD) equation. A cumulative distribution function (CDF) for defect time durations in days (or any other time unit based on the convention of the model user) can be developed. Cumulative distribution functions can define the probability (in fraction or percentages) that the random variable X is less than or equal to a certain number Y. For example, a CDF can be used to normalize numerical data to fractions and make subsequent computations easier and faster. After plotting the CDF of defect times for the temperature surveys example, a plot equation correlating X and Y axis can be obtained and referred to as a probability of defect (PD).

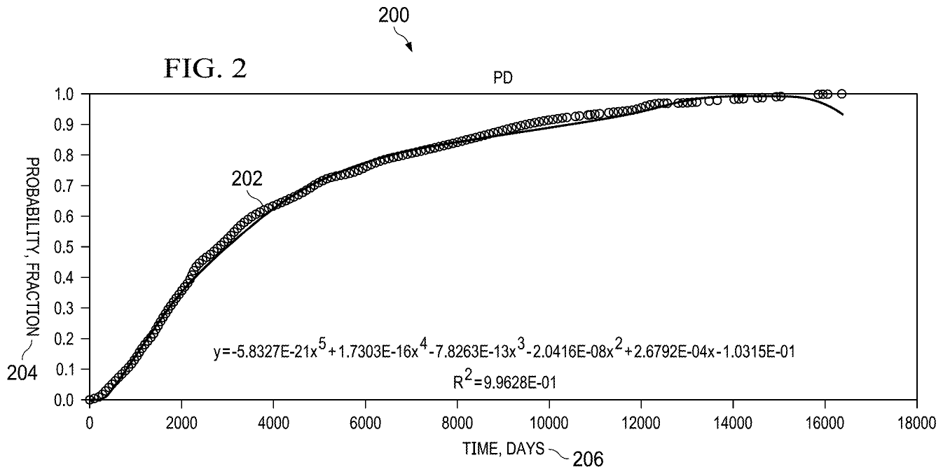

FIG. 2 is a diagram showing an example of a cumulative distribution function (CDF) 200 including a PD 202, according to some implementations of the present disclosure. The PD 202 is plotted relative to a probability (or fraction) 204 and a time 206 (for example, in days). The PD 202 is plotted relative to an equation:

y=−5.8327E-21x⁵+1.7303E-16x⁴−7.8263E-13x³−2.0416E-08x² +2.6792E-04x−1.0315E-01 (1)

where a coefficient of determination, r-squared (R²)=9.9628E-01.

A step for developing a cumulative distribution function for health data points can also be used to obtain a probability of health (PH) equation. Similar to defect data points, a CDF for health data points can be developed, and a PH can be obtained.

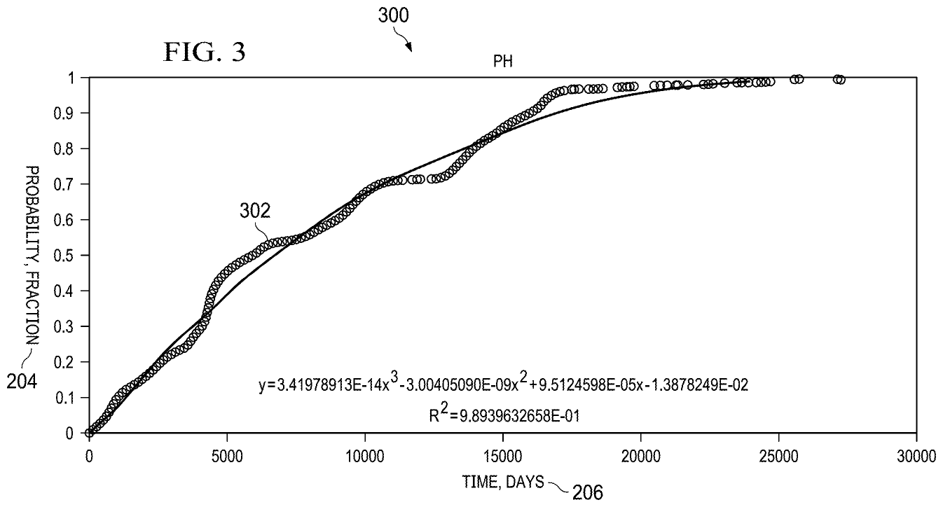

FIG. 3 is a diagram showing an example of a CDF 300 including a probability of health (PH) 302, according to some implementations of the present disclosure. The PH 302 is plotted relative to the probability (or fraction) 204 and the time 206 (for example, in days). The PH 302 is plotted relative to an equation:

y=3.41978913E-14x³−3.00405090E-09x²+9.5124598E-05x−1.3878249E-02 (2)

where R²=9.8939632658E-01.

In a step for calculating an overall probability of failure (P_{f}), an overall asset probability of failure function can be calculated based on the collective inputs of both defect and health functions. The equations development of the overall probability of failure function is as follows:

$${P}_{f} = \frac{D}{D + H} \qquad ( 3 )$$

where the probability of failure function is simply the number of defects over a total number data points (both defects and health).

Additionally, P_{f} can also be expressed as:

$${P}_{f} = \frac{D}{D + H D + H H} \qquad ( 4 )$$

where the probability of failure function is similar to Equation (3), but Equation (4) accounts for the health distinctions. The health data points can be classified based on time intervals for wells that were healthy in one interval and continue to be healthy for a subsequent interval (HH), and for wells that were healthy in the current time interval and became defective at a later interval.

P_{f} can also be expressed as:

$${P}_{f} = \frac{{D}_{N} \times P D ( t \leq {t}_{0} )}{{D}_{N} \times P D ( t \leq {t}_{0} ) + {D}_{N} \times P D ( t > {t}_{0} ) + {H}_{N} \times P H ( t > {t}_{0} )} \qquad ( 5 )$$

where the probability of failure function in Equation (4) is re-represented in CDF terms after both defect and health data points are normalized into fractions. The D_{N} and H_{N} terms are defined as the total number of defects and total number of health data points, respectively.

P_{f} can also be expressed as:

$${P}_{f} = \frac{{D}_{N} \times P D ( t \leq {t}_{0} )}{[ {D}_{N} + {H}_{N} \times P H ( t > {t}_{0} ) ]} \qquad ( 6 )$$

where the probability of failure function in Equation (5) is simplified by taking DN in the denominator as a common factor, leaving the summation of PD(t≤t₀)+PD(t>t₀) to be 1. Equation (6) can represent a final format for which the overall probability of failure that accounts for both health and defect data points.

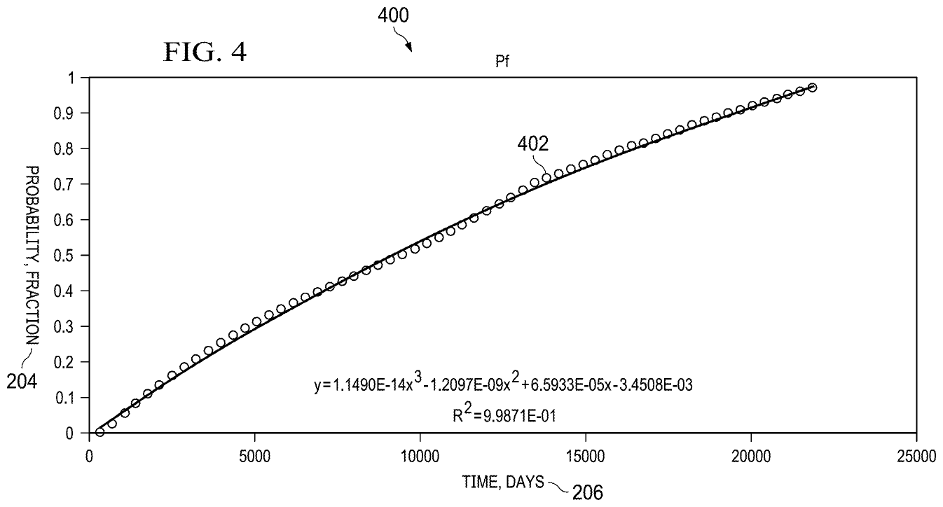

FIG. 4 is a diagram showing an example of a calculated overall probability of failure for temperature surveys 400 including a probability of failure 402, according to some implementations of the present disclosure. The P_{f} 402 is plotted relative to the probability (or fraction) 204 and the time 206 (for example, in days). The P_{f} 402 is plotted relative to an equation:

y=1.1490E-14x³−1.2097E-09x²+6.5933E-05x −3.4508E-03 (7)

where R²=9.9871E-01. Information presented in the graph shown in FIG. 4 can be used in a decision making process for the user to select an appropriate frequency.

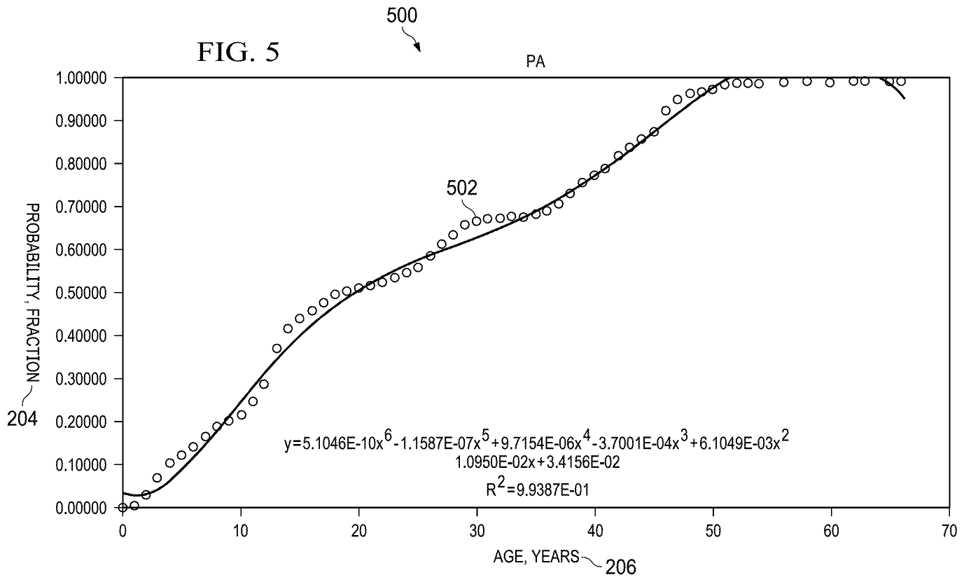

A step for developing a cumulative distribution function for age data points can be used to obtain a probability of age (PA) equation. The respective asset/equipment age can be calculated after identifying a reference time point as previously described. A CDF for asset/equipment age can be developed similar to PD and PH functions and a PA equation can be obtained. The equipment age distribution in CDF format can be used in a normalizing calculation. Knowledge of asset/equipment age distribution can aid in quantifying the existing wells under a specific optimization scenario, which can be used in turn to calculate the probability of failure. The use of the PA function is shown in subsequent calculation steps. The probability of age (PA) for the temperature survey example can be seen in FIG. 5.

FIG. 5 is a diagram showing an example of a probability of age for temperature surveys 500 including a probability of age 502, according to some implementations of the present disclosure. The PA 502 is plotted relative to the probability (or fraction) 204 and the time 206 (for example, in years). The PA 502 is plotted relative to an equation:

y=5.1046E-10x⁶−1.1587E-07x⁵+9.7154E-06x⁴−3.7001E-04x³+6.1049E-03x²−1.0950E-02x (8)

where R²=9.9387E-01. If a user selects a frequency represented in FIG. 5, all subsequent surveys/inspections can be made on the same timeframe of the selected frequency. For example, a temperature survey frequency of two years can be compared to a current single year, further entailing that a next temperature survey should be made two years after the last recorded temperature survey.

In a step for reproducing PA over multiple scenarios using a survey time, existing wells can be calculated. Using the selected time analysis previously described, the probability of age can be reproduced over multiple foreseen optimization scenarios. Optimization scenarios for an annual survey can be a 2-, 3-, or 4-year frequency. The probability of age can be used in delta form to calculate existing wells meeting equipment age categories out of the total number of wells. For example, using a delta PA (of one year, for example) of 0.02895049 with a total number of wells of 1844, the existing wells with an asset/equipment age of less than one year would be the product of 0.02895049 and 1844, resulting in 53.38 wells. Tables 1A and 1B collectively shows the results of reproducing PA over multiple scenarios for the temperature surveys example:

TABLE 1A
Reproducing PA Over Multiple Scenarios

| | | | | | | Delta | | Delta | |
|---|---|---|---|---|---|---|---|---|---|
| | | | | | PA | PA | PA | PA | Continued |
| | Time | PD | PH | P_{f} | (1 Year) | (1 Year) | (2 Year) | (2 Year) | in Table 1B |
| 1 | 365 | 0.00811 | 0.02044 | 0.00262 | 0.02895 | 0.02895 | 0.03416 | 0.03416 | . . . |
| 2 | 730 | 0.08130 | 0.05398 | 0.02690 | 0.03387 | 0.00492 | 0.02895 | 0.00000 | . . . |
| 3 | 1095 | 0.16496 | 0.08673 | 0.05587 | 0.04702 | 0.01315 | 0.03387 | 0.00492 | . . . |
| 4 | 1460 | 0.24281 | 0.11871 | 0.08418 | 0.06672 | 0.01971 | 0.04702 | 0.01315 | . . . |
| 5 | 1825 | 0.31486 | 0.14993 | 0.11175 | 0.09150 | 0.02477 | 0.06672 | 0.01971 | . . . |
| 6 | 2190 | 0.38115 | 0.18040 | 0.13848 | 0.12002 | 0.02853 | 0.09150 | 0.02477 | . . . |
| 7 | 2555 | 0.44181 | 0.21012 | 0.16431 | 0.15117 | 0.03115 | 0.12002 | 0.02853 | . . . |
| 8 | 2920 | 0.49697 | 0.23912 | 0.18919 | 0.18396 | 0.03278 | 0.15117 | 0.03115 | . . . |
| 9 | 3285 | 0.54685 | 0.26740 | 0.21308 | 0.21754 | 0.03358 | 0.18396 | 0.03278 | . . . |
| 10 | 3650 | 0.59166 | 0.29497 | 0.23596 | 0.25121 | 0.03368 | 0.21754 | 0.03358 | . . . |
| 11 | 4015 | 0.63169 | 0.32183 | 0.25783 | 0.28440 | 0.03319 | 0.25121 | 0.03368 | . . . |
| 12 | 4380 | 0.66721 | 0.34801 | 0.27870 | 0.31663 | 0.03223 | 0.28440 | 0.03319 | . . . |
| 13 | 4745 | 0.69856 | 0.37351 | 0.29859 | 0.34755 | 0.03091 | 0.31663 | 0.03223 | . . . |
| 14 | 5110 | 0.72608 | 0.39833 | 0.31756 | 0.37686 | 0.02932 | 0.34755 | 0.03091 | . . . |
| 15 | 5475 | 0.75010 | 0.42249 | 0.33565 | 0.40439 | 0.02753 | 0.37686 | 0.02932 | . . . |
| 16 | 5840 | 0.77100 | 0.44601 | 0.35294 | 0.43002 | 0.02563 | 0.40439 | 0.02753 | . . . |
| 17 | 6205 | 0.78915 | 0.46888 | 0.36952 | 0.45371 | 0.02368 | 0.43002 | 0.02563 | . . . |
| 18 | 6570 | 0.80491 | 0.49112 | 0.38549 | 0.47545 | 0.02174 | 0.45371 | 0.02368 | . . . |
| 19 | 6935 | 0.81866 | 0.51274 | 0.40095 | 0.49531 | 0.01986 | 0.47545 | 0.02174 | . . . |
| 20 | 7300 | 0.83075 | 0.53375 | 0.41602 | 0.51339 | 0.01808 | 0.49531 | 0.01986 | . . . |

TABLE 1B
Reproducing PA Over Multiple Scenarios (continued)

| | (continued | | | | Delta | | | | Delta |
|---|---|---|---|---|---|---|---|---|---|
| | from | PA | Delta PA | PA | PA | PA | Delta PA | PA | PA |
| | Table 1A) | (3 Year) | (3 Year) | (4 Year) | (4 Year) | (5 Year) | (5 Year) | (6 Year) | (6 Year) |
| 1 | | | | | | | | | |
| 2 | . . . | 0.03416 | 0.03416 | | | | | | |
| 3 | . . . | 0.02895 | 0.00000 | 0.03416 | 0.03416 | | | | |
| 4 | . . . | 0.03387 | 0.00492 | 0.02895 | 0.00000 | 0.03416 | 0.03416 | | |
| 5 | . . . | 0.04702 | 0.01315 | 0.03387 | 0.00492 | 0.02895 | 0.00000 | 0.03416 | 0.03416 |
| 6 | . . . | 0.06672 | 0.01971 | 0.04702 | 0.01315 | 0.03387 | 0.00492 | 0.02895 | 0.00000 |
| 7 | . . . | 0.09150 | 0.02477 | 0.06672 | 0.01971 | 0.04702 | 0.01315 | 0.03387 | 0.00492 |
| 8 | . . . | 0.12002 | 0.02853 | 0.09150 | 0.02477 | 0.06672 | 0.01971 | 0.04702 | 0.01315 |
| 9 | . . . | 0.15117 | 0.03115 | 0.12002 | 0.02853 | 0.09150 | 0.02477 | 0.06672 | 0.01971 |
| 10 | . . . | 0.18396 | 0.03278 | 0.15117 | 0.03115 | 0.12002 | 0.02853 | 0.09150 | 0.02477 |
| 11 | . . . | 0.21754 | 0.03358 | 0.18396 | 0.03278 | 0.15117 | 0.03115 | 0.12002 | 0.02853 |
| 12 | . . . | 0.25121 | 0.03368 | 0.21754 | 0.03358 | 0.18396 | 0.03278 | 0.15117 | 0.03115 |
| 13 | . . . | 0.28440 | 0.03319 | 0.25121 | 0.03368 | 0.21754 | 0.03358 | 0.18396 | 0.03278 |
| 14 | . . . | 0.31663 | 0.03223 | 0.28440 | 0.03319 | 0.25121 | 0.03368 | 0.21754 | 0.03358 |
| 15 | . . . | 0.34755 | 0.03091 | 0.31663 | 0.03223 | 0.28440 | 0.03319 | 0.25121 | 0.03368 |
| 16 | . . . | 0.37686 | 0.02932 | 0.34755 | 0.03091 | 0.31663 | 0.03223 | 0.28440 | 0.03319 |
| 17 | . . . | 0.40439 | 0.02753 | 0.37686 | 0.02932 | 0.34755 | 0.03091 | 0.31663 | 0.03223 |
| 18 | . . . | 0.43002 | 0.02563 | 0.40439 | 0.02753 | 0.37686 | 0.02932 | 0.34755 | 0.03091 |
| 19 | . . . | 0.45371 | 0.02368 | 0.43002 | 0.02563 | 0.40439 | 0.02753 | 0.37686 | 0.02932 |
| 20 | . . . | 0.47545 | 0.02174 | 0.45371 | 0.02368 | 0.43002 | 0.02563 | 0.40439 | 0.02753 |

In a step for calculating the number of failures for each scenario, the actual number of failures can be calculated for proposed optimization scenarios. The existing wells number corresponding to each scenario can be used along with Delta P_{f} numbers (where P_{f} is generated as previously described) to calculate the number of failed wells by using the product of the two numbers. A cumulative summation of each scenario can be used to quantify the number of expected failures. Table 2 below shows example calculations for temperature surveys scenarios.

TABLE 2
Expected Failures

| Existing | Expected | Existing | Expected | Existing | Expected | Existing | Expected | Existing | Expected |
|---|---|---|---|---|---|---|---|---|---|
| Wells | Failures | Wells | Failures | Wells | Failures | Wells | Failures | Wells | Failures |
| (1 Year) | (1 Year) | (2 Years) | (2 Year) | (3 Years) | (3 Year) | (4 Years) | (4 Year) | (5 Years) | (5 Year) |
| 53.3847 | 0.1400 | 32.5310 | 0.0853 | 31.0745 | 0.0815 | 30.5003 | 0.0800 | 30.1256 | 0.0790 |
| 9.0666 | 0.2201 | 0.0000 | 0.0000 | 32.5310 | 0.7897 | 31.0745 | 0.7543 | 30.5003 | 0.7404 |
| 24.2517 | 0.7026 | 8.9066 | 0.2580 | 0.0000 | 0.0000 | 32.5310 | 0.9425 | 31.0745 | 0.9003 |
| 36.3367 | 1.0289 | 23.8239 | 0.6746 | 8.7538 | 0.2479 | 0.0000 | 0.0000 | 32.5310 | 0.9212 |
| 45.6776 | 1.2591 | 35.6956 | 0.9839 | 23.4152 | 0.6454 | 8.6039 | 0.2372 | 0.0000 | 0.0000 |
| 52.6074 | 1.4063 | 44.8717 | 1.1995 | 35.0833 | 0.9378 | 23.0141 | 0.6152 | 8.4569 | 0.2261 |
| 57.4365 | 1.4836 | 51.6793 | 1.3349 | 44.1020 | 1.1392 | 34.4823 | 0.8907 | 22.6209 | 0.5843 |
| 60.4533 | 1.5040 | 56.4232 | 1.4037 | 50.7928 | 1.2637 | 43.3465 | 1.0784 | 33.8932 | 0.8432 |
| 61.9250 | 1.4794 | 59.3868 | 1.4188 | 55.4553 | 1.3248 | 49.9226 | 1.1927 | 42.6060 | 1.0179 |
| 62.0982 | 1.4209 | 60.8325 | 1.3919 | 58.3680 | 1.3356 | 54.5053 | 1.2472 | 49.0698 | 1.1228 |
| 61.1998 | 1.3384 | 61.0027 | 1.3341 | 59.7890 | 1.3075 | 57.3681 | 1.2546 | 53.5742 | 1.1716 |
| 59.4373 | 1.2403 | 60.1202 | 1.2546 | 59.9563 | 1.2511 | 58.7647 | 1.2263 | 56.3881 | 1.1767 |
| 56.9997 | 1.1340 | 58.3888 | 1.1616 | 59.0889 | 1.1755 | 58.9292 | 1.1723 | 57.7608 | 1.1491 |
| 54.0583 | 1.0252 | 55.9942 | 1.0619 | 57.3871 | 1.0883 | 58.0766 | 1.1014 | 57.9224 | 1.0984 |
| 50.7670 | 0.9185 | 53.1046 | 0.9608 | 55.0336 | 0.9957 | 56.4040 | 1.0205 | 57.0844 | 1.0328 |
| 47.2635 | 0.8173 | 49.8714 | 0.8624 | 52.1937 | 0.9026 | 54.0909 | 0.9354 | 55.4405 | 0.9587 |
| 43.6693 | 0.7240 | 46.4297 | 0.7698 | 49.0159 | 0.8127 | 51.2995 | 0.8505 | 53.1668 | 0.8815 |
| 40.0912 | 0.6401 | 42.8989 | 0.6849 | 45.6332 | 0.7285 | 48.1762 | 0.7691 | 50.4231 | 0.8050 |
| 36.6212 | 0.5662 | 39.3839 | 0.6089 | 42.1630 | 0.6518 | 44.8514 | 0.6934 | 47.3532 | 0.7321 |
| 33.3377 | 0.5025 | 35.9752 | 0.5422 | 38.7083 | 0.5834 | 41.4407 | 0.6246 | 44.0852 | 0.6645 |
| 30.3060 | 0.4488 | 32.7496 | 0.4850 | 35.3580 | 0.5237 | 38.0452 | 0.5635 | 40.7328 | 0.6033 |
| 27.5789 | 0.4048 | 29.7714 | 0.4370 | 32.1878 | 0.4724 | 34.7523 | 0.5101 | 37.3952 | 0.5489 |
| 25.1975 | 0.3698 | 27.0924 | 0.3976 | 29.2607 | 0.4294 | 31.6364 | 0.4643 | 34.1586 | 0.5013 |
| 23.1918 | 0.3433 | 24.7530 | 0.3664 | 26.6277 | 0.3942 | 28.7594 | 0.4258 | 31.0959 | 0.4603 |
| 21.5813 | 0.3249 | 22.7826 | 0.3430 | 24.3284 | 0.3663 | 26.1715 | 0.3940 | 28.2681 | 0.4256 |
| 20.3761 | 0.3143 | 21.2006 | 0.3270 | 22.3918 | 0.3454 | 23.9116 | 0.3688 | 25.7244 | 0.3968 |
| 19.5770 | 0.3111 | 20.0166 | 0.3181 | 20.8369 | 0.3311 | 22.0082 | 0.3498 | 23.5031 | 0.3735 |
| 19.1765 | 0.3153 | 19.2316 | 0.3162 | 19.6733 | 0.3235 | 20.4800 | 0.3368 | 21.6322 | 0.3557 |
| 19.1594 | 0.3268 | 18.8382 | 0.3213 | 18.9017 | 0.3224 | 19.3362 | 0.3298 | 20.1301 | 0.3433 |
| 19.5037 | 0.3451 | 18.8214 | 0.3331 | 18.5150 | 0.3276 | 18.5779 | 0.3288 | 19.0059 | 0.3363 |
| 20.1807 | 0.3699 | 19.1596 | 0.3512 | 18.4986 | 0.3391 | 18.1978 | 0.3336 | 18.2605 | 0.3347 |
| 21.1564 | 0.4002 | 19.8247 | 0.3750 | 18.8309 | 0.3562 | 18.1817 | 0.3440 | 17.8870 | 0.3384 |
| 22.3916 | 0.4346 | 20.7831 | 0.4033 | 19.4846 | 0.3781 | 18.5083 | 0.3592 | 17.8711 | 0.3468 |
| 23.8430 | 0.4707 | 21.9966 | 0.4343 | 20.4266 | 0.4033 | 19.1508 | 0.3781 | 18.1921 | 0.3591 |
| 25.4636 | 0.5057 | 23.4224 | 0.4651 | 21.6193 | 0.4293 | 20.0767 | 0.3987 | 18.8236 | 0.3738 |
| 27.2033 | 0.5354 | 25.0143 | 0.4924 | 23.0206 | 0.4531 | 21.2489 | 0.4182 | 19.7337 | 0.3884 |
| 29.0100 | 0.5551 | 26.7234 | 0.5114 | 24.5852 | 0.4705 | 22.6262 | 0.4330 | 20.8859 | 0.3997 |
| 30.8300 | 0.4061 | 28.4983 | 0.3754 | 26.2650 | 0.3460 | 24.1641 | 0.3183 | 22.2397 | 0.2929 |
| 32.6085 | 0.4165 | 30.2861 | 0.3869 | 28.0094 | 0.3578 | 25.8150 | 0.3298 | 23.7513 | 0.3034 |
| 34.2906 | 0.4370 | 32.0332 | 0.4083 | 29.7666 | 0.3794 | 27.5296 | 0.3509 | 25.3740 | 0.3234 |
| 35.8218 | 0.4550 | 33.6856 | 0.4278 | 31.4837 | 0.3999 | 29.2566 | 0.3716 | 27.0593 | 0.3437 |
| 37.1489 | 0.4696 | 35.1899 | 0.4449 | 33.1078 | 0.4186 | 30.9444 | 0.3912 | 28.7568 | 0.3636 |
| 38.2203 | 0.4804 | 36.4935 | 0.4587 | 34.5862 | 0.4347 | 32.5406 | 0.4090 | 30.4157 | 0.3823 |
| 38.9869 | 0.4866 | 37.5460 | 0.4686 | 35.8675 | 0.4476 | 33.9937 | 0.4243 | 31.9847 | 0.3992 |
| 39.4030 | 0.4877 | 38.2991 | 0.4741 | 36.9019 | 0.4568 | 35.2531 | 0.4364 | 33.4130 | 0.4136 |
| 39.4264 | 0.4834 | 38.7078 | 0.4746 | 37.6421 | 0.4616 | 36.2698 | 0.4447 | 34.6508 | 0.4249 |
| 39.0196 | 0.4734 | 38.7308 | 0.4699 | 38.0438 | 0.4615 | 36.9973 | 0.4488 | 35.6501 | 0.4325 |
| 38.1505 | 0.4574 | 38.3313 | 0.4595 | 38.0664 | 0.4564 | 37.3921 | 0.4483 | 36.3652 | 0.4360 |
| 36.7924 | 0.4354 | 37.4774 | 0.4435 | 37.6737 | 0.4458 | 37.4143 | 0.4427 | 36.7533 | 0.4349 |
| 34.9255 | 0.4074 | 36.1433 | 0.4216 | 36.8345 | 0.4297 | 37.0283 | 0.4319 | 36.7751 | 0.4290 |
| 26.7961 | 0.3078 | 34.3094 | 0.3941 | 35.5233 | 0.4081 | 36.2035 | 0.4159 | 36.3958 | 0.4181 |
| 0.0000 | 0.0000 | 26.3234 | 0.2974 | 33.7208 | 0.3810 | 34.9147 | 0.3945 | 35.5850 | 0.4021 |
| 0.0000 | 0.0000 | 0.0000 | 0.0000 | 25.8718 | 0.2872 | 33.1432 | 0.3679 | 34.3183 | 0.3810 |
| 0.0000 | 0.0000 | 0.0000 | 0.0000 | 0.0000 | 0.0000 | 25.4286 | 0.2771 | 32.5770 | 0.3550 |
| 0.0000 | 0.0000 | 0.0000 | 0.0000 | 0.0000 | 0.0000 | 0.0000 | 0.0000 | 24.9942 | 0.2670 |
| Sum of | 32.5310 | | 31.0745 | | 30.5003 | | 30.1256 | | 29.7939 |
| Expected | | | | | | | | | |
| Failures | | | | | | | | | |
| Percentage | %1.76 | | %1.69 | | %1.65 | | %1.63 | | %1.62 |
| of Expected | | | | | | | | | |
| Failures | | | | | | | | | |

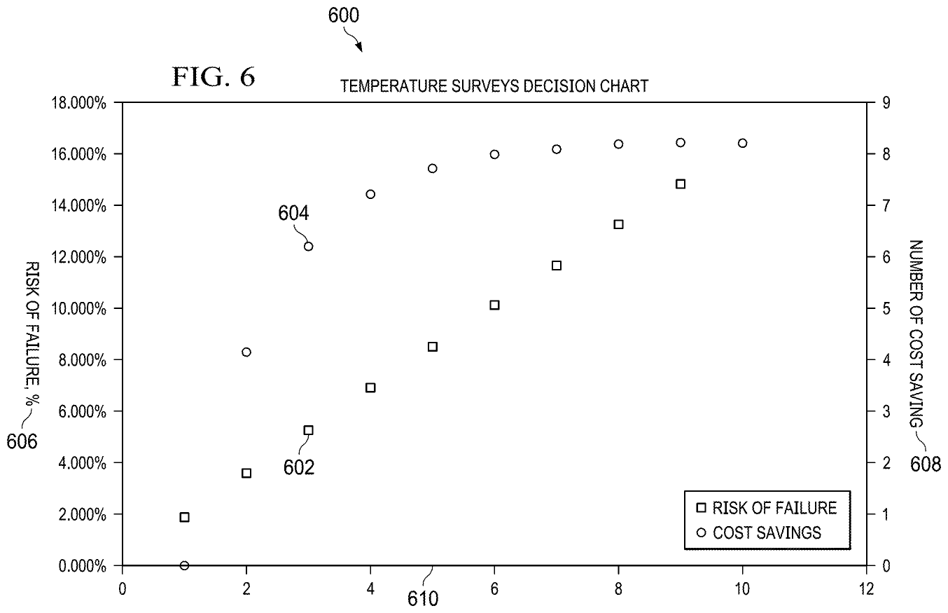

In a step for selecting the optimum surveillance scenario, based on the generated data from previous steps, several scenarios for frequencies can be presented along with their associated risks and avoided costs. For the temperature surveys example, the decision chart showing cumulative risk of failure percentages along with cost saving figures can be presented, as shown in FIG. 6.

FIG. 6 is a graph 600 showing examples of a risk of failure plot 602 and a cost savings plot 604, according to some implementations of the present disclosure. The risk of failure plot 602 is plotted relative to a risk of failure percentage axis 606. The cost savings plot 604 is plotted relative to a number of cost savings axis 608. Cost savings can be presented, for example, in monetary units such as hundreds or thousands of dollars, or using other figures or units that enable financial comparisons. The plots 602 and 604 are plotted relative to a time axis 610 (for example, in years).

An optimum frequency can be selected out the forecasted optimization scenarios at the discretion of the asset/equipment owner, where the decision balances calculated risk and financial impact. It is recommended to conservatively optimize the proactive surveys compared to the reactive surveys. The proactive surveys generally include maintenance accompanying the survey, which could prolong the lifespan of the asset/equipment, which does not occur with reactive surveys.

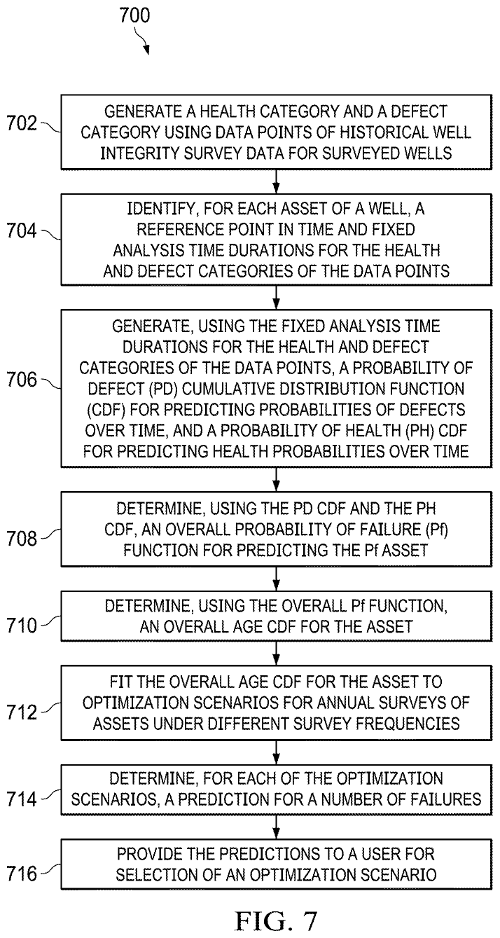

FIG. 7 is a flowchart of an example of a method 700 for selecting an optimized survey frequency for a well based on defect and health probabilities, according to some implementations of the present disclosure. For clarity of presentation, the description that follows generally describes method 700 in the context of the other figures in this description. However, it will be understood that method 700 can be performed, for example, by any suitable system, environment, software, and hardware, or a combination of systems, environments, software, and hardware, as appropriate. In some implementations, various steps of method 700 can be run in parallel, in combination, in loops, or in any order.

At 702, a health category and a defect category are generated from data points of historical well integrity survey data for surveyed wells. As an example, the health category can include data points for periods of time that well maintenance is not needed for leaks in downhole pipes of the well, and the defect category can include data points for periods of time that an anomalous temperature profile indicates a presence of downhole pipe leaks in the well requiring maintenance. From 702, method 700 proceeds to 704.

At 704, for each asset of a well, a reference point in time and fixed analysis time durations are generated for the health and defect categories of the data points. For example, the reference point in time can be an initial installation date of a pipe or a replacement date of the pipe. A defect time duration can be a time period defined by the reference point in time and a failure of the pipe, and a healthy time duration can be a time period defined by the reference point in time and a present time that the pipe is still healthy. From 704, method 700 proceeds to 706.

At 706, a probability of defect (PD) cumulative distribution function (CDF) for predicting probabilities of defects over time is generated using the fixed analysis time durations for the health and defect categories of the data points. A probability of health (PH) CDF for predicting health probabilities over time is also generated using the fixed analysis time durations for the health and defect categories of the data points. Example CDFs associated with the probabilities of defects and health are described with reference to FIGS. 2 and 3. From 706, method 700 proceeds to 708.

At 708, an overall probability of failure (P_{f}) function for predicting the P_{f} for the asset is determined using the PD CDF and the PH CDF. For example, determining the overall P_{f} function can include using a failure function representing a number of defects over a total number data points of defects and health. In some implementations, determining the overall P_{f} function includes using a failure function representing health data points classified based on time intervals for wells that were healthy in one interval and continue to be healthy for a subsequent interval and the wells that were healthy in a current time interval and became defective at a later time interval. In some implementations, determining the overall P_{f} function includes using a failure function incorporating terms of the P_{f} CDF and the PH CDF normalized into fractions. From 708, method 700 proceeds to 710.

At 710, an overall age CDF for the asset is determined using the P_{f} CDF, the PH CDF, and the overall P_{f} function. As an example, Equations 8 can be used to determine overall age probabilities. From 710, method 700 proceeds to 712.

At 712, the overall age CDF for the asset is fitted to optimization scenarios for annual (or regularly scheduled) surveys of assets under different survey frequencies. The different survey frequencies can include, for example, survey frequencies of two, three, and four years. From 712, method 700 proceeds to 714.

At 714, a prediction for a number of failures is determined for each of the optimization scenarios. As an example, failures such as described with reference to Table 2 can be generated. From 714, method 700 proceeds to 716.

At 716, the predictions are provided to a user for selection of an optimization scenario. As an example, the predictions can be presented to a user in the form of a graph of FIG. 6, with user controls for selecting and implementing maintenance schedules for assets. After 716 method 700 can stop.

In some implementations, method 700 further includes updating a survey frequency for the well using the user-selected optimization scenario.

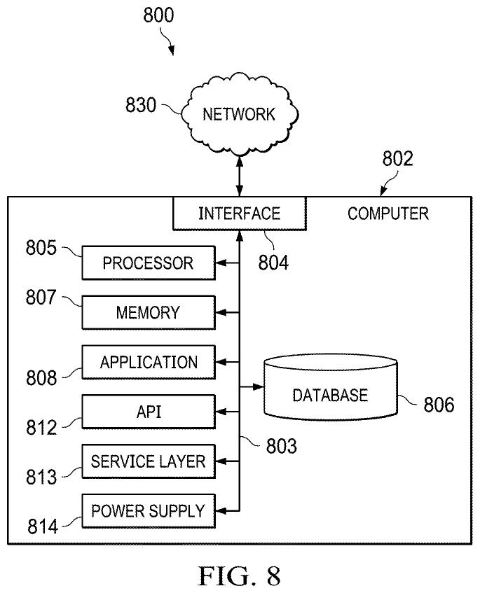

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a top level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both) over the system bus 803. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs.

The service layer 813 can provide software services to the computer 802 and other components (whether illustrated or not) that are communicably coupled to the computer 802. The functionality of the computer 802 can be accessible for all service consumers using this service layer. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 also includes a database 806 that can hold data for the computer 802 and other components connected to the network 830 (whether illustrated or not). For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

The application 808 can be an algorithmic software engine providing functionality according to particular needs, desires, or particular implementations of the computer 802 and the described functionality. For example, application 808 can serve as one or more components, modules, or applications. Further, although illustrated as a single application 808, the application 808 can be implemented as multiple applications 808 on the computer 802. In addition, although illustrated as internal to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Described implementations of the subject matter can include one or more features, alone or in combination.

For example, in a first implementation, a computer-implemented method includes the following. A health category and a defect category are generated from data points of historical well integrity survey data for surveyed wells. For each asset of a well, a reference point in time and fixed analysis time durations are generated for the health and defect categories of the data points. A probability of defect (PD) cumulative distribution function (CDF) for predicting probabilities of defects over time is generated using the fixed analysis time durations for the health and defect categories of the data points. A probability of health (PH) CDF for predicting health probabilities over time is also generated using the fixed analysis time durations for the health and defect categories of the data points. An overall probability of failure (P_{f}) function for predicting the P_{f} for the asset is determined using the PD CDF and the PH CDF. An overall age CDF for the asset is determined using the overall P_{f} function. The overall age CDF for the asset is fitted to optimization scenarios for annual surveys of assets under different survey frequencies. A prediction for a number of failures is determined for each of the optimization scenarios. The predictions are provided to a user for selection of an optimization scenario.

The foregoing and other described implementations can each, optionally, include one or more of the following features:

A first feature, combinable with any of the following features, where the health category includes data points for periods of time that well maintenance is not needed for leaks in downhole pipes of the well, and where the defect category includes data points for periods of time that an anomalous temperature profile indicates a presence of downhole pipe leaks in the well requiring maintenance.

A second feature, combinable with any of the previous or following features, where the reference point in time is an initial installation date of a pipe, a replacement date of the pipe, where a defect time duration is a time period defined by the reference point in time and a failure of the pipe, and where a healthy time duration is a time period defined by the reference point in time and a present time that the pipe is still healthy.

A third feature, combinable with any of the previous or following features, where determining the overall P_{f} function includes using a failure function representing a number of defects over a total number data points of defects and health.

A fourth feature, combinable with any of the previous or following features, where determining the overall P_{f} function includes using a failure function representing health data points classified based on time intervals for wells that were healthy in one interval and continue to be healthy for a subsequent interval and the wells that were healthy in a current time interval and became defective at a later time interval.

A fifth feature, combinable with any of the previous or following features, where determining the overall P_{f} function includes using a failure function incorporating terms of the Pf CDF and the PH CDF normalized into fractions.

A sixth feature, combinable with any of the previous or following features, where the different survey frequencies include survey frequencies of two, three, and four years.

A seventh feature, combinable with any of the previous or following features, where the method further includes updating a survey frequency for the well using the user-selected optimization scenario.

In a second implementation, a non-transitory, computer-readable medium stores one or more instructions executable by a computer system to perform operations including the following. A health category and a defect category are generated from data points of historical well integrity survey data for surveyed wells. For each asset of a well, a reference point in time and fixed analysis time durations are generated for the health and defect categories of the data points. A probability of defect (PD) cumulative distribution function (CDF) for predicting probabilities of defects over time is generated using the fixed analysis time durations for the health and defect categories of the data points. A probability of health (PH) CDF for predicting health probabilities over time is also generated using the fixed analysis time durations for the health and defect categories of the data points. An overall probability of failure (P_{f}) function for predicting the P_{f} for the asset is determined using the PD CDF and the PH CDF. An overall age CDF for the asset is determined using the overall P_{f} function. The overall age CDF for the asset is fitted to optimization scenarios for annual surveys of assets under different survey frequencies. A prediction for a number of failures is determined for each of the optimization scenarios. The predictions are provided to a user for selection of an optimization scenario.

The foregoing and other described implementations can each, optionally, include one or more of the following features:

A first feature, combinable with any of the following features, where the health category includes data points for periods of time that well maintenance is not needed for leaks in downhole pipes of the well, and where the defect category includes data points for periods of time that an anomalous temperature profile indicates a presence of downhole pipe leaks in the well requiring maintenance.

A second feature, combinable with any of the previous or following features, where the reference point in time is an initial installation date of a pipe, a replacement date of the pipe, where a defect time duration is a time period defined by the reference point in time and a failure of the pipe, and where a healthy time duration is a time period defined by the reference point in time and a present time that the pipe is still healthy.

A third feature, combinable with any of the previous or following features, where determining the overall P_{f} function includes using a failure function representing a number of defects over a total number data points of defects and health.

A fourth feature, combinable with any of the previous or following features, where determining the overall P_{f} function includes using a failure function representing health data points classified based on time intervals for wells that were healthy in one interval and continue to be healthy for a subsequent interval and the wells that were healthy in a current time interval and became defective at a later time interval.

A fifth feature, combinable with any of the previous or following features, where determining the overall P_{f} function includes using a failure function incorporating terms of the P_{f} CDF and the PH CDF normalized into fractions.

A sixth feature, combinable with any of the previous or following features, where the different survey frequencies include survey frequencies of two, three, and four years.

A seventh feature, combinable with any of the previous or following features, where the operations further include updating a survey frequency for the well using the user-selected optimization scenario.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. A health category and a defect category are generated from data points of historical well integrity survey data for surveyed wells. For each asset of a well, a reference point in time and fixed analysis time durations are generated for the health and defect categories of the data points. A probability of defect (PD) cumulative distribution function (CDF) for predicting probabilities of defects over time is generated using the fixed analysis time durations for the health and defect categories of the data points. A probability of health (PH) CDF for predicting health probabilities over time is also generated using the fixed analysis time durations for the health and defect categories of the data points. An overall probability of failure (P_{f}) function for predicting the P_{f} for the asset is determined using the PD CDF and the PH CDF. An overall age CDF for the asset is determined using the overall P_{f} function. The overall age CDF for the asset is fitted to optimization scenarios for annual surveys of assets under different survey frequencies. A prediction for a number of failures is determined for each of the optimization scenarios. The predictions are provided to a user for selection of an optimization scenario.

The foregoing and other described implementations can each, optionally, include one or more of the following features:

A first feature, combinable with any of the following features, where the health category includes data points for periods of time that well maintenance is not needed for leaks in downhole pipes of the well, and where the defect category includes data points for periods of time that an anomalous temperature profile indicates a presence of downhole pipe leaks in the well requiring maintenance.

A second feature, combinable with any of the previous or following features, where the reference point in time is an initial installation date of a pipe, a replacement date of the pipe, where a defect time duration is a time period defined by the reference point in time and a failure of the pipe, and where a healthy time duration is a time period defined by the reference point in time and a present time that the pipe is still healthy.

A third feature, combinable with any of the previous or following features, where determining the overall P_{f} function includes using a failure function representing a number of defects over a total number data points of defects and health.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
generating a health category and a defect category of data points of historical well integrity survey data for surveyed wells;
identifying, for each asset used in a well, a reference point in time and fixed analysis time durations for the health and defect categories of the data points;
generating, using the fixed analysis time durations for the health and defect categories of the data points, a probability of defect (PD) cumulative distribution function (CDF) for predicting probabilities of defects over time, and a probability of health (PH) CDF for predicting health probabilities over time;
determining, using the PD CDF and the PH CDF, an overall probability of failure (P_{f}) function for predicting the P_{f} for the asset;
determining, using the P_{f} CDF, and the overall P_{f} function, an overall age CDF for the asset;
fitting the overall age CDF for the asset to optimization scenarios for annual surveys of assets under different survey frequencies;
determining, for each of the optimization scenarios, a prediction for a number of failures; and
providing the predictions to a user for selection of an optimization scenario.

2. The computer-implemented method of claim 1, wherein the health category includes data points for periods of time that well maintenance is not needed for leaks in downhole pipes of the well, and wherein the defect category includes data points for periods of time that an anomalous temperature profile indicates a presence of downhole pipe leaks in the well requiring maintenance.

3. The computer-implemented method of claim 1, wherein the reference point in time is an initial installation date of a pipe, a replacement date of the pipe, wherein a defect time duration is a time period defined by the reference point in time and a failure of the pipe, and wherein a healthy time duration is a time period defined by the reference point in time and a present time that the pipe is still healthy.

4. The computer-implemented method of claim 1, wherein determining the overall P_{f} function includes using a failure function representing a number of defects over a total number data points of defects and health.

5. The computer-implemented method of claim 1, wherein determining the overall P_{f} function includes using a failure function representing health data points classified based on time intervals for wells that were healthy in one interval and continue to be healthy for a subsequent interval and the wells that were healthy in a current time interval and became defective at a later time interval.

6. The computer-implemented method of claim 1, wherein determining the overall P_{f} function includes using a failure function incorporating terms of the P_{f} CDF and the PH CDF normalized into fractions.

7. The computer-implemented method of claim 1, wherein the different survey frequencies include survey frequencies of two, three, and four years.

8. The computer-implemented method of claim 1, further comprising:
updating a survey frequency for the well using the user-selected optimization scenario.

9. A non-transitory, computer-readable medium storing one or more instructions executable by a computer system to perform operations comprising:
generating a health category and a defect category of data points of historical well integrity survey data for surveyed wells;
identifying, for each asset used in a well, a reference point in time and fixed analysis time durations for the health and defect categories of the data points;
generating, using the fixed analysis time durations for the health and defect categories of the data points, a probability of defect (PD) cumulative distribution function (CDF) for predicting probabilities of defects over time, and a probability of health (PH) CDF for predicting health probabilities over time;
determining, using the PD CDF and the PH CDF, an overall probability of failure (P_{f}) function for predicting the P_{f} for the asset;
determining, using the P_{f} CDF, and the overall P_{f} function, an overall age CDF for the asset;
fitting the overall age CDF for the asset to optimization scenarios for annual surveys of assets under different survey frequencies;
determining, for each of the optimization scenarios, a prediction for a number of failures; and
providing the predictions to a user for selection of an optimization scenario.

10. The non-transitory, computer-readable medium of claim 9, wherein the health category includes data points for periods of time that well maintenance is not needed for leaks in downhole pipes of the well, and wherein the defect category includes data points for periods of time that an anomalous temperature profile indicates a presence of downhole pipe leaks in the well requiring maintenance.

11. The non-transitory, computer-readable medium of claim 9, wherein the reference point in time is an initial installation date of a pipe, a replacement date of the pipe, wherein a defect time duration is a time period defined by the reference point in time and a failure of the pipe, and wherein a healthy time duration is a time period defined by the reference point in time and a present time that the pipe is still healthy.

12. The non-transitory, computer-readable medium of claim 9, wherein determining the overall P_{f} function includes using a failure function representing a number of defects over a total number data points of defects and health.

13. The non-transitory, computer-readable medium of claim 9, wherein determining the overall P_{f} function includes using a failure function representing health data points classified based on time intervals for wells that were healthy in one interval and continue to be healthy for a subsequent interval and the wells that were healthy in a current time interval and became defective at a later time interval.

14. The non-transitory, computer-readable medium of claim 9, wherein determining the overall P_{f} function includes using a failure function incorporating terms of the P_{f} CDF and the PH CDF normalized into fractions.

15. The non-transitory, computer-readable medium of claim 9, wherein the different survey frequencies include survey frequencies of two, three, and four years.

16. The non-transitory, computer-readable medium of claim 9, the operations further comprising:
updating a survey frequency for the well using the user-selected optimization scenario.

17. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
generating a health category and a defect category of data points of historical well integrity survey data for surveyed wells;
identifying, for each asset used in a well, a reference point in time and fixed analysis time durations for the health and defect categories of the data points;
generating, using the fixed analysis time durations for the health and defect categories of the data points, a probability of defect (PD) cumulative distribution function (CDF) for predicting probabilities of defects over time, and a probability of health (PH) CDF for predicting health probabilities over time;
determining, using the PD CDF and the PH CDF, an overall probability of failure (P_{f}) function for predicting the P_{f} for the asset;
determining, using the P_{f} CDF, and the overall P_{f} function, an overall age CDF for the asset;
fitting the overall age CDF for the asset to optimization scenarios for annual surveys of assets under different survey frequencies;
determining, for each of the optimization scenarios, a prediction for a number of failures; and
providing the predictions to a user for selection of an optimization scenario.

18. The computer-implemented system of claim 17, wherein the health category includes data points for periods of time that well maintenance is not needed for leaks in downhole pipes of the well, and wherein the defect category includes data points for periods of time that an anomalous temperature profile indicates a presence of downhole pipe leaks in the well requiring maintenance.

19. The computer-implemented system of claim 17, wherein the reference point in time is an initial installation date of a pipe, a replacement date of the pipe, wherein a defect time duration is a time period defined by the reference point in time and a failure of the pipe, and wherein a healthy time duration is a time period defined by the reference point in time and a present time that the pipe is still healthy.

20. The computer-implemented system of claim 17, wherein determining the overall P_{f} function includes using a failure function representing a number of defects over a total number data points of defects and health.
